(19) United States
(12) Patent Application Publication
(10) Pub. No.: US 2025/0111029 A1
(43) Pub. Date: Apr. 3, 2025

(54) IMPLEMENTING USER AUTHENTICATION WITH A WEARABLE DEVICE

(71) Applicant: Microsoft Technology Licensing, LLC, Redmond, WA (US)

(72) Inventors: Sean Michael FROHMAN, Seattle, WA (US); Scott FUDALLY, Redmond, WA (US); Robert D. YOUNG, Kirkland, WA (US); Henri A. AUTIO, Kirkland, WA (US); Augustus TERTZAKIAN, Kirkland, WA (US); David ABZARIAN, Kenmore, WA (US); Hamza MUSTAFA, Redmond, WA (US)

(21) Appl. No.: 18/478,195

(22) Filed: Sep. 29, 2023

(51) Int. Cl. G06F 21/35; H04W 12/08; H04W 12/33; H04W 12/63

(52) U.S. Cl. CPC G06F 21/35; H04W 12/08; H04W 12/33; H04W 12/63

(57) ABSTRACT

A computing device is disclosed that exchanges wireless communications with a wearable device and processes the communications to determine the position and direction of motion of the wearable device, and the authentication status of the wearable device. The device then grants access based on these determinations. The wearable device authenticates a user and communicates with the user computing device to enable determination of its position, motion direction, and authentication status. Also disclosed are methods for user authentication and de-authentication based on user presence and absence.

### TECHNICAL FIELD

Aspects of the disclosure are related to the fields of computer hardware and software and, in particular, to authentication techniques and wearable technologies.

### BACKGROUND

Contemporary digital systems and devices are increasingly interconnected, with several features necessitating user identification or authentication to ensure appropriate and secure access. For instance, personal computing devices, such as smartphones, tablets or laptops, often include multiple applications and functionalities that require user-specific information. In some cases, user access is controlled based on a password, fingerprint recognition, or facial recognition. While effective to a degree, these methods have certain inconveniences and risks associated with them.

On the one hand, remembering and typing complicated passwords can be challenging and time-consuming for users. Biometric methods, such as fingerprint or facial recognition, have helped in this regard, but these methods can sometimes fail in situations where the user's hands are occupied, or if the lighting conditions are not suitable for face recognition. Additionally, these methods might not be sufficient for certain sensitive applications that require fool-proof user authentication.

Wearable technology provides a possible alternative for user authentication. Items such as smartwatches or fitness bands are typically always worn by the individual, and therefore represent a shortcut for user recognition. However, existing systems and methods of leveraging wearables for user authentication are not entirely efficient, reliable or convenient, presenting a need for enhanced solutions for user authentication using wearable devices.

### Overview

Various implementations disclosed herein relate to a computing device and a method for controlling access to a computing device based on wireless communications exchanged with a wearable device. The computing device includes storage media, processors, and program instructions that direct the computing device to exchange wireless communications with the wearable device, process the communications to determine the position and direction of motion of the wearable device, and to determine the authentication status of the wearable device. The computing device then grants access based on these determinations. The wearable device authenticates the user and communicates with the user computing device to enable determination of its position, motion direction, and authentication status. The disclosure also describes methods for user authentication and de-authentication based on user presence and absence. Notably, the systems exchange data via ultra-wideband signals and may also utilize Bluetooth Low-Energy signals. The wearable device may have a bracelet form factor to be worn by the user, in some implementations.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational architecture in an implementation.

FIG. 2 illustrates an access control process in an implementation.

FIG. 3 illustrates another access control process in an implementation.

FIG. 4 illustrates an operational sequence in an implementation.

FIGS. 5A-5C illustrate various operational scenarios in an implementation.

FIG. 6 illustrates another operational architecture in an implementation.

FIG. 7 illustrates a wearable device architecture in an implementation.

FIG. 8 illustrates an operational sequence in an implementation.

FIG. 9 illustrates a computing system suitable for implementing the various operational environments, architectures, processes, scenarios, and sequences discussed below with respect to the other Figures.

### DETAILED DESCRIPTION

Various implementations disclosed herein provide improved information security surrounding the access to and operation of secure computing devices such as laptop and desktop computers, server computers, tablet computers, mobile phones, and the like. The disclosed solutions define and control access to a secure computing device based on the fulfillment of several conditions associated with the location (position) and direction of movement of a wearable computing device.

This unique and innovative concept adds a layer of security to the computing device by considering both the physical position and movement direction of a nearby wearable device. Computer program instructions, as embodied by algorithms implemented by the computing device, are programmed to analyze the location and motion direction of the wearable device and check if these meet pre-set criteria for distance and direction. This feature offers the possible technical effect of granting or denying access to the computing device based on these uniquely defined parameters. It may function as an added security measure, a theft deterrent, or a way to safeguard crucial information stored on or accessible through the computing device.

Another feature disclosed herein is the use of a wireless device's authentication status. The computing device's program instructions mandate review of the wearable device's authentication before enabling access. This implies that access to the computing device is possible only when the authentication status of the connecting wearable device has been authenticated positively. It enforces a two-factor authentication process—position and movement direction of the wearable device alongside the authentication status of the wearable device, which offers an added layer of verification to determine whether the device user is authorized. This complex but user-friendly approach ensures the computing device is accessed only by a specific user or group of users, providing improved security.

The combination of these features improves traditional approaches to device security by making security agile and highly responsive to the situation at hand. Not only do the implementations disclosed herein evaluate a potential user on position and direction, but they also further cross-verify based on digital certification via the wearable device's status. Such an intelligent and secure approach offers the potential to achieve a high degree of trust and reliability when taking into account the twin concepts of convenience and information security.

The present application is related to a computing device, in collaboration with a wearable device, and the use of Ultra-Wideband (UWB) signals to determine the position and direction of motion of the wearable device with respect to the computing device. The technology capitalizes on the unique properties of UWB signals, such as their extensive frequency range and high data transfer rate, to ascertain the accurate spatial relations between the computing device and the wearable device. An advantage lies in the ability to effectively enable contextual interactions and real-time tracking of user inputs based on movement and position data of the wearable device.

The secured computing device includes a hardware processor and a non-transitory computer-readable medium storing program instructions. When these program instructions are executed by the processor, they cause the computing device to generate UWB signals and send them to the wearable device. The computing device is further configured to receive UWB signals from the wearable device, thereby establishing a two-way communication path. The strength, timing, and nature of the received signals carry information about the distance and relative motion of the wearable device, which aids in deriving the position and motion details of the wearable device.

The computing device is equipped with the capability to analyze the characteristics of the received UWB signals from the wearable device, such as signal strength, signal-to-noise ratio, time of flight (ToF), and phase difference. By leveraging these high-resolution signal properties, the computing device can ascertain the relative position and direction of the wearable device with a high degree of accuracy and in real-time. Such spatial awareness can enable a multitude of applications, including but not limited to, access control programs and interfaces.

In some implementations, the communication system within the computing device is configured to initiate an exchange of UWB signals with the wearable device when the presence of the wearable device is detected via other wireless signals that are different from the UWB signals. These different wireless signals may be of different frequencies or different types, such as Bluetooth, Bluetooth Low Energy (BTLE), or Wi-Fi signals. By utilizing these other wireless signals, the computing device can more effectively recognize and establish efficient communication when the wearable device is nearby.

Once the computing device detects the wearable device's presence through the alternative wireless signals, the instructions within the computing device direct it to transition to using UWB signals for exchanging information with the wearable device. This way, it optimizes speed, efficiency, and reduces interference. The UWB signals offer high speed, high bandwidth data transmission, enabling rapid and efficient two-way communication between the computing device and the wearable device. The high-speed data transmission facilitated by these UWB signals can support a variety of applications and functionalities, thus greatly enhancing the user's wearable device experience.

The wearable device may come in the form of a wearable bracelet, intended primarily for use by a user. A distinguishing characteristic of the wearable device is its innovative form factor it fulfills the style and convenience paradigms associated with wearable jewelry, such as a bracelet in this case, while offering robust computation abilities typically related to portable computing devices. The computer-aided bracelet device is designed to fit comfortably around the wrist of a user, making it easy to carry and use, providing seamless access to sophisticated computation and communication technologies. It may be appreciated that other form factors are possible and are contemplated herein. For example, the wearable device may come in the form factor of a watch, eyeglasses, an earring, a belt, or the like.

The wearable devices contemplated herein embrace effective miniaturization of computing components, intricately incorporating them into the design of a wearable bracelet. The bracelet form factor allows for the strategic placement of processing units, data storage units, power supply units, and communication interfaces, all crafted to maintain an optimal balance between aesthetic appeal and technical functionality. The device leverages the advancement of technologies, such as flexible display screens (optional), low-power high-performance processors, and high-storage compact memory modules, to ensure user-friendly interaction while maintaining the sophistication of a computing device. It can potentially incorporate an array of sensors and transducers to enable specific applications, such as fitness tracking, remote communication, environmental interaction, and potentially aiding in healthcare, in addition to the secure access capabilities disclosed herein. Owing to its compact and wearable nature, the wearable devices disclosed herein facilitate convenience and close-to-body usage. This means that the device can be worn by users for extended periods without causing discomfort, allowing for continuous use and interaction. Furthermore, the device could potentially learn from users' behaviors and adapt its functionalities according to user patterns, providing a novel level of personalization.

The noted above, a wearable computing device disclosed herein is designed to offer advanced user authentication and wireless communication capabilities. The wearable device is built with one or more processors that are operationally linked with one or more computer-readable storage media. The wearable device operates according to program instructions stored on the connected computer-readable storage media. These instructions, when executed by the device's processor(s), direct the functioning of the wearable computing device. In particular, the executing instructions command the wearable device to authenticate a user linked with the device. This user authentication process ensures the secure use of the device, as only recognized and verified users can operate it. The authentication process safeguards the device against unauthorized access and misuse, thereby elevating its security and the protection of any data or operation associated with it.

The wearable device is also able to engage in wireless communications with a user computing device (e.g., a laptop). The wireless communication ability enables the wearable device to interact with other electronic equipment without the need for direct physical connections. During the wireless communication exchange, the wearable device provides the user computing device with the information necessary to determine its relative position and direction of motion.

The wearable device, aside from sending its location and motion data, also transmits information about its authentication status. This communication lets the user computing device know whether or not the wearable device has been correctly authenticated. The exchange of authentication information fortifies the security setup by adding a further level of validation that ensures the user computing device is interacting with a verified and authorized wearable computing device.

As a whole, the implementations disclosed herein embody a technologically advanced wearable computing device that couples enhanced user authentication protocols with wireless communication capabilities. The wearable device's unique ability to continually update its location, movement direction, and authentication status to a user computing device allows for more secure, controlled, and dynamic usage. These aspects, therefore, represent a significant step forward in wearable technology, with potential benefits for various applications where secure and remotely trackable device interactions are required.

The wearable devices disclosed herein may also incorporate program instructions to detect the presence or absence of a user based on one or more physiological factors. These physiological factors may include—but are not limited to—heart rate, skin temperature, perspiration level, respiratory rate, etc. Identifying the proximity of the user through these signals enables the wearable device to be efficient, discreet, and without any requirement for input from the user. This technology allows the wearable computing device to adopt smart functioning modality, where it is able to recognize, identify, and authenticate the user's presence in a more personalized and secured way.

Upon the successful detection of the user, the program instructions may authenticate the user. This authentication process may involve verifying physiological data from the user against previously stored data. The device uses its built-in biosensors to track the physiological factors of the user, steadily monitoring for any significant changes. For example, the sensors could be tracking the user's heart rate, and once the heart rate matches with the pre-saved information, the device authenticates the user, thus giving them access to any restricted content or functionality. Hence, this method may ensure a highly sophisticated, biometric-based authentication that offers a robust solution against potential unauthorized usage.

In some implementations, an administrator may control an access policy that governs which user may access a given user computer device or environment. For example, an administrator may control whether a specific user can access a specific laptop or other such device when physically approaching the user device within the position and motion criteria contemplated herein. In addition, a policy associated with a specific user could be transferred from device to device. For example, a user may receive or otherwise have an access policy deployed to a specific machine, upon which the user can transfer the policy to other devices that may participate in similar authentication processes.

The specific distance threshold may also be configurable by the administrator. For instance, the distance threshold may require a user to be very close to a highly sensitive device or environment, whereas the distance threshold may be more relaxed with respect to less sensitive device or environment. The administrator may adjust the threshold via a slider mechanism or other such element for adjusting the range, allowing for the distance threshold to be increased or decreased with ease. Similarly, the administrator may adjust an overall sensitivity level via a slider mechanism or other such element. For instance, an administrator may increase the security sensitivity of a specific user computer device, thereby restricting or narrowing the distance threshold within which the user must be before being granted access to the device. The same adjustment may make the device more sensitive or demanding with respect to confidence of the position and motion of the wearable. In contrast, adjusting the security level down may increase the distance threshold and possibly reduce the precision with which the position and motion of the wearable device is ascertained.

The ability to determine the distance from a target that a wearable device via a physical medium such as UWB provides several advantages. For example, many “Proof of Presence” Universal Serial Devices (USB) are often simply inserted into a computing device that has access to resources that require user authentication. However, the USB devices are often left plugged into the computing device for convenience, or by accident. By adding the capability to determine the distance within an environment enables an information technology (IT) professional within an enterprise environment or Consumer within a personal/home environment to create authentication policies requiring that the user be within a specified distance/threshold from a target device. For example, the user/wearable must be within 3 feet (or less) for the authentication to be approved.

On the detection of user's absence, the program instructions embedded within the wearable computing device may initiate a swift de-authentication process. The system will discontinue the user's access to secured data and information, safeguarding against potential misuse or unauthorized access. This feat is achieved by the constant monitoring of physiological factors—identifying when these factors no longer correspond to the authenticated user, signifying their absence. The moment an absence is affirmed, de-authentication is accomplished, securing the device's resources until the authorized user is detected again. This innovative device cleverly blends convenience with security, making it an asset in the evolving domain of wearable technology.

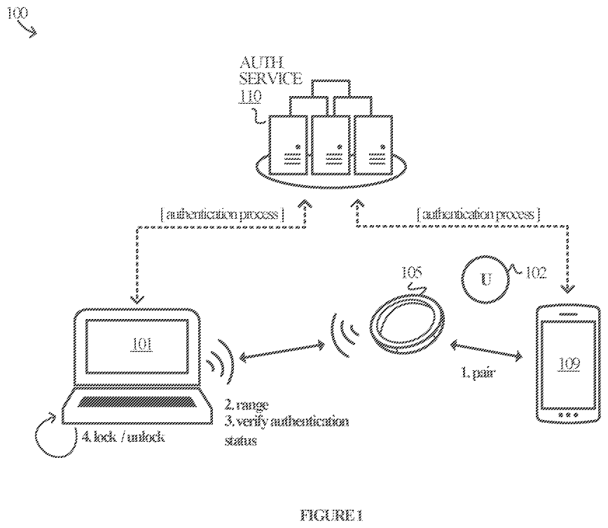

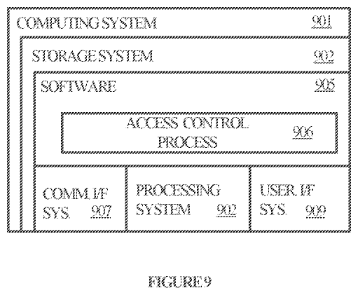

Turning now to the drawings, FIG. 1 illustrates an operational architecture 100 in an implementation. Operational architecture 100 includes a computing device 101, a wearable device 105, a mobile device 109, and an authorization service 110. Computing device 101, wearable device 105, and mobile device 109 may each be implemented using a suitable computing architecture, an example of which is provided below with respect to computing system 901 in FIG. 9.

Examples of computing device 101 include laptop and desktop computers, server computers, and any other type of computing device with respect to which access must be securely and efficiently controlled. Wearable device 105 is representative of any computing device capable of interfacing with computing device 101 and mobile device 109 for purposes of enhancing the provisioning and delivery of secure access control. Wearable device 105 comes in a form factor that is convenient and easy to use such as a bracelet, ring, eyeglasses, belt, or the like. Examples of mobile device 109 include mobile phones, tablet devices, and the like.

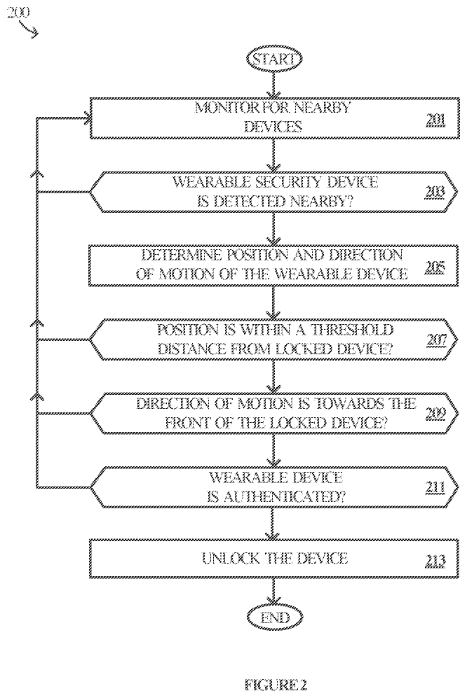

FIG. 2 illustrates an access control process 200 employed by a computing device (e.g., computing device 101) to govern access by users to the device. Access control process 200 may be implemented in program instructions (software and/or firmware) by one or more processors of the computing device. The program instructions direct the computing device to operate as follows, referring parenthetically to the steps in FIG. 2.

To begin, the computing device monitors for nearby devices (step 201). It is assumed for illustrative purposes that the computing device is in a locked mode, whether asleep, in a low power state, or otherwise. The computing device may monitor nearby devices by scanning for wireless signals propagated by those devices such as Bluetooth signals, Wi-Fi signals, or the like. The computing device senses its surrounding environment and determines from such signals whether a wearable security device is nearby (step 203). If so, the computing device determines a position of the wearable, as well as a direction of movement of the wearable (step 205). If not, the computing device returns to monitoring for nearby devices.

At step 205, the computing device may determine the position and movement of the wearable device by exchanging wireless signals with the wearable device in accordance with a suitable wireless protocol that provides for such determination. For example, the computing device may communicate with the wearable device using ultra-wideband (UWB) radio technology. The computing device uses the position information to determine whether the wearable device is within a threshold distance from the computing device (step 207). If so, the computing device proceeds to determine whether the wearable device is moving away from or towards the computing device (step 209). In addition, the computing device considers whether the wearable device is located at the front of the computing device, or to its rear.

If the relative motion of the wearable device is such that it is not moving towards the computing device, or is doing so from the rear, then computing device continues to monitor the position and/or direction of the wearable device. However, if the wearable device is moving towards the computing device from the front (and is within the threshold distance), the computing device proceeds to determine whether the wearable device is authenticated with respect to a valid user of the computing device (step 211). The computing device may authenticate the wearable device by connecting to it via a wireless protocol that differs with respect to the protocol used to range the wearable, and exchange authentication communications over the new connection. If the wearable is successfully authenticated, the computing device may proceed to unlock the screen or otherwise grant access to the device (step 213). If the wearable is not successfully authenticated, then the computing device remains locked and returns to monitoring.

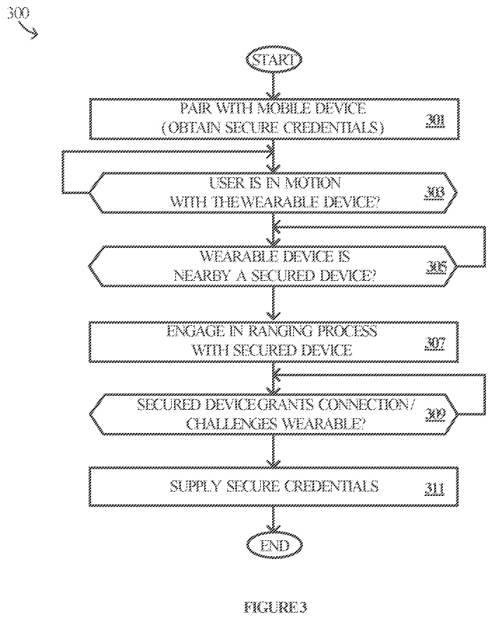

FIG. 3 illustrates an access control process 300 employed by a wearable device (e.g., wearable device 105) to obtain access to a secured computing device (e.g., computing device 101) on behalf of a user. Access control process 300 may be implemented in program instructions (software and/or firmware) by one or more processors of the wearable device. The program instructions direct the wearable device to operate as follows, referring parenthetically to the steps in FIG. 3.

To begin, the wearable device connects to and/or pairs with a mobile device to obtain secure credentials associated with a user/owner of the device (step 301). A security application on the mobile device interfaces with the wearable device, as well as an authorization service in the cloud capable of authenticating the user. Assuming the user is validly authenticated by the application/mobile device, the mobile device provides security credentials to the wearable device, which the wearable device may assert when attempting to connect to other devices.

The wearable device then monitors motion or other such events that indicate that a user is wearing the device and is physically moving (step 303). The wearable device may do so by monitoring one or more internal sensors such as gyroscope, a temperature sensor, and the like. If the user is not in motion, then the wearable device continues monitoring for motion. However, if the user is in motion with the wearable device, then the wearable begins to monitor for the presence of secured devices nearby (step 305). The wearable may monitor for nearby devices by listening to or otherwise receiving wireless signals emitted by such devices such as UWB beacons, BTLE beacons, Wi-Fi beacons, and the like. If no nearby devices are found, the wearable continues to monitor for their presence. However, if a secured device is discovered nearby, then the wearable device engages with the secured device in a ranging process, to allow the secured device to determine the position and motion vector of the wearable (307). For example, the wearable may exchange UWB communications with the computing device, from which the computing device is able to ascertain the relevant information.

Assuming that the wearable device is sufficiently close to the secured device, positioned in front of the device, and is moving towards the device, the secured device will proceed to an authentication step where the wearable device is challenged for its authentication credentials (step 309). The wearable device provides its credentials to the secured device in furtherance of the authentication process, with the intent of proving to the secured computing device that the user wearing the wearable may be granted access to the computer (step 311).

The computing device validates the wearable device and/or the user based on the credentials, including by potentially communicating with the same authentication service that initially authenticated the same user via the mobile device and application. This manner, the highly secure authentication of the user provided by the mobile device and application may be carried forward to the secured computing device by way of the wearable device, substantially improving device security and providing a convenient user experience.

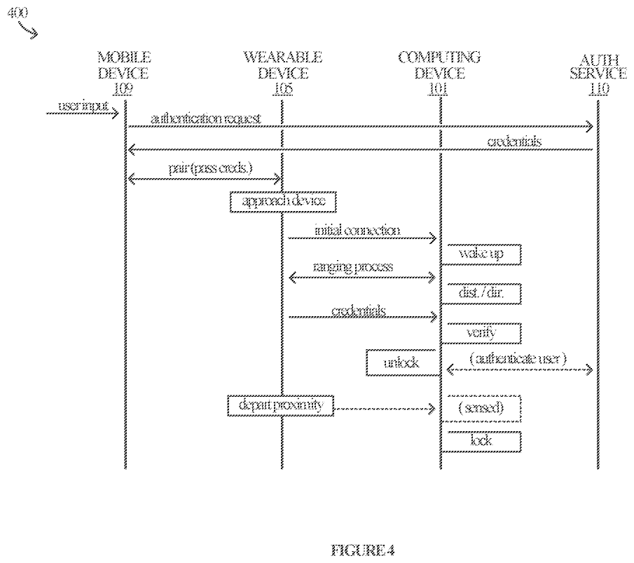

FIG. 4 illustrates operational sequence 400 in a brief example of an application of both access control process 200 (FIG. 2) and access control process 300 (FIG. 3) as applied to computing device 101 and wearable device 105 respectively in the context of FIG. 1.

To begin, a user 102 supplies user input to mobile device 109 in furtherance of an authentication process engaged in by an authentication application on mobile device 109 with respect to authorization service 110. The application communicates and coordinates with authorization service 110 to validate the user, thereby authenticating mobile device 109 as validly belonging to and being in the possession of the user. The user input may include, for example, biometric identification information, a personal identification number (PIN), a password, or any other suitable user input used in such processes.

Assuming that the user is authenticated by the authorization service, the service returns electronic credentials to mobile device 109 that may be used by the same or other applications on the device when accessing other services. For example, the credentials may be used by an email application on the device to securely access an email service. Here, the credentials are also used to provide an authentication mechanism by which wearable device 105 may authenticate the user to computing device 101. Accordingly, mobile device 109 passes credential information to wearable device 105 upon connecting to and pairing with the wearable.

The user eventually picks up the wearable device and moves towards computing device 101. For example, the user may wear the device on the user's wrist and proceed to walk from one room distant from computing device 101, to another room (e.g., home office) where computing device 101 is kept. As the user moves through the dwelling, wearable device 105 broadcasts a signal heard by computing device 101. The signal causes computing device 101 to wake-up and begin a ranging process with wearable device 105 over an UWB radio channel.

The ranging process allows computing device 101 to ascertain not only the position/location of wearable device 105, but also its general heading or direction. That is, computing device 101 is able to calculate a motion vector that describes the velocity and direction of wearable device 105. The position and vector information allows computing device 101 to determine whether wearable device 105 is sufficiently close to it, as well as whether the user is in-front of the computer and/or moving towards or away from the computer. If all three criteria are met, then computing device 101 may proceed to authenticating the wearable.

Authenticating the wearable includes computing device 101 communicating with wearable device 105 over a separate channel via which the credential information may be securely exchanged. Assuming that the credentials remain valid, computing device 101 may unlock its screen or otherwise grant access to the user. In some cases, the user is granted access without having to perform any additional steps such as entering a PIN or submitting to facial recognition. In other cases, additional steps may be required of the user above and beyond the authentication provided by the wearable device.

The user may engage with one or more applications on computing device 101 for a period of time. Eventually, it is assumed that the user moves on to a different task at a different location. Accordingly, once the user has ceased to use the computer, computing device 101 begins to monitor for the user's departure. Computing device 101 may do so by again ranging wearable device 105 to ascertain its position and vector. Upon sensing that the user is sufficiently distant from or otherwise moving away from the computer, computing device 101 may lock the screen to prevent any unwarranted access.

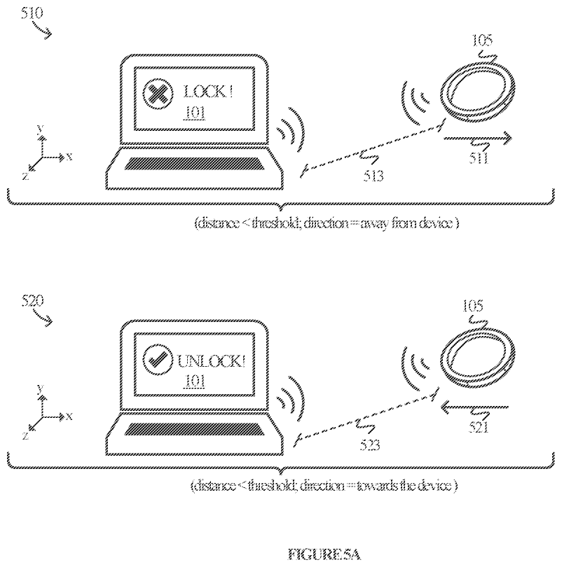

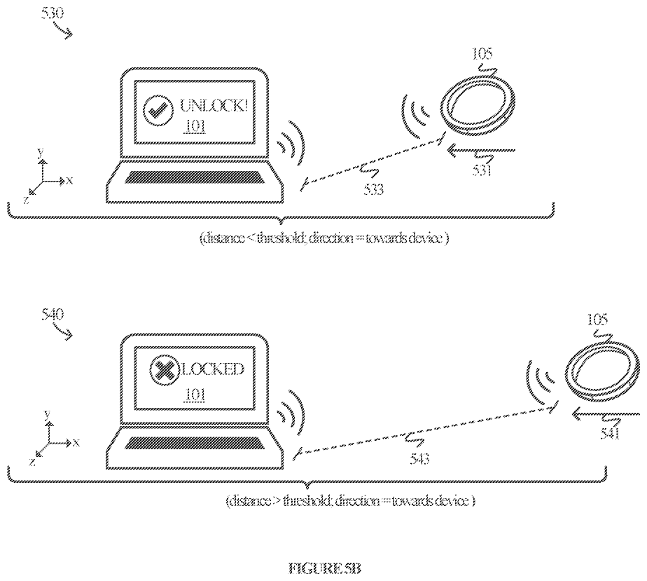

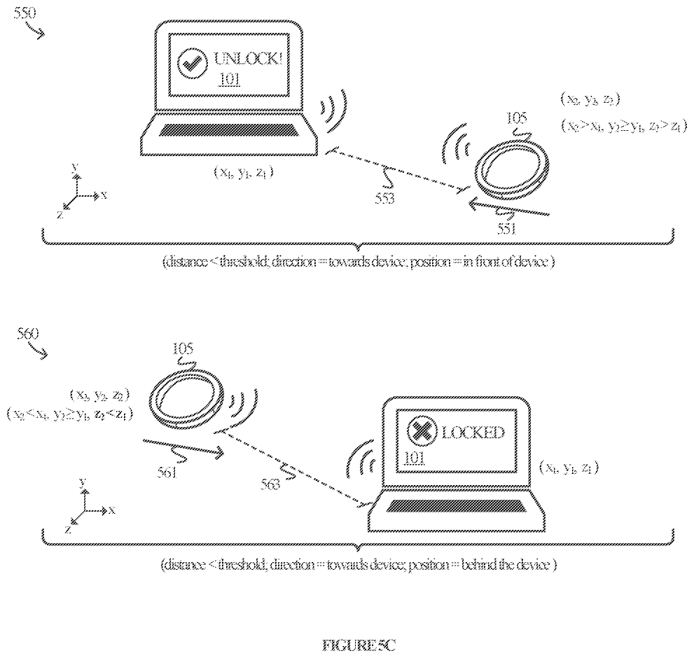

FIGS. 5A-5C illustrate various scenarios associated with the elements of FIG. 1 that may be understood as occurring in-series or independently of each other. Each of the scenarios assumes that wearable device 105 has been validly authenticated and remains so.

Beginning with scenario 510 in FIG. 5A, a user (not shown) puts on wearable device 105 and is moving in the vicinity of computing device 101. Here, the distance 513 is assumed to be within a threshold distance away from computing device 101. However, the motion vector 511 of wearable device 105 is such that its direction of motion is away from computing device 101, even though the wearable is position in front of computing device 101 in the x-y-z access. Accordingly, computing device 101 remains locked and neither the user nor other users may access it. In contrast, scenario 520 in FIG. 5A illustrates a situation whereby the distance 523 of wearable device 105 is again within a threshold distance from computing device 101 and is positioned in front of the device. In addition, the user is approaching computing device 101 as represented by motion vector 521. Accordingly, computing device 101 may unlock itself grant the user with access.

In FIG. 5B, scenario 530 illustrates a situation where the distance 533 of wearable device 105 is within a threshold distance from computing device 101 and is positioned in front of the device. In addition, the user is approaching computing device 101 as represented by motion vector 531. Accordingly, computing device 101 may unlock itself grant the user with access. In contrast, in scenario 540, even though the motion vector 541 of wearable device 105 indicates motion towards computing device 101, and its position is in front of the device, its distance 543 exceeds the threshold distance. Computing device 101 therefore blocks access and the user is unable to login—which would be prohibitive due to the distance. Rather, since the distance threshold is exceeded, other users (potentially malicious) would also be unable to login to computing device 101.

FIG. 5C illustrates two scenarios that demonstrate what happens when a wearable is sufficiently close to and moving towards a secured computing device, but from behind, rather than from the front of the device. In scenario 550, wearable device 105 is a distance 553 that is sufficiently close and has a vector 551 that indicates motion towards computing device 101. In addition, the position of wearable device 105 is in front of computing device 101 as illustrated by their relative coordinates in the x-y-z plane. Thus, the user is granted access to computing device 101. In contrast, in scenario 560, wearable device 105 is sufficiently close to computing device 101 per distance 563, and its vector 561 indicates the appropriate motion. However, the position of wearable device 105 in the x-y-z plane indicates that it is positioned behind computing device 101. Accordingly, the user is denied access to computing device 101.

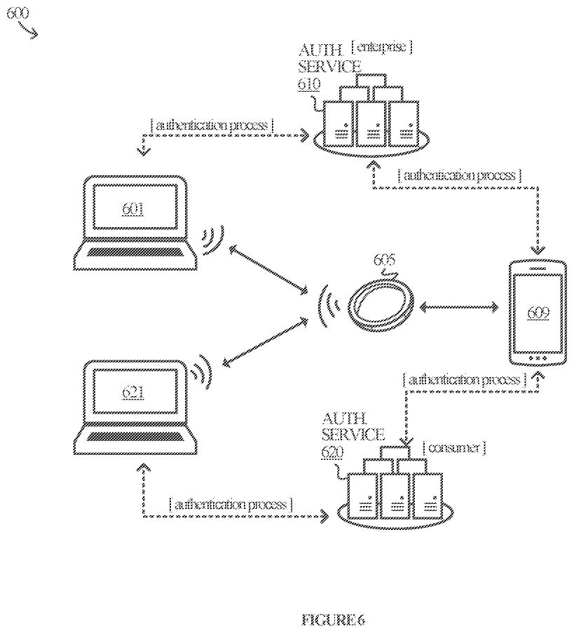

FIG. 6 illustrates operational architecture 600 in another implementation that demonstrates the ability of a single wearable device to assist with access control with respect to multiple devices secured by different authorization services. For example, one service may provide enterprise-level authorization, while another service may provide consumer-oriented authorization. Operational architecture 600 includes computing devices 601 and 621, mobile device 609, wearable device 605, and authorization services 610 and 620.

In operation, a single user associated with mobile device 609 can be authenticated by one or both of authorization services 610 and 620. Wearable device 605 interfaces with mobile device 609 as described above to obtain credentials for the respective authorizations. Wearable device 605 may thus provide the appropriate credential when proximate to and prompted by one or the other of computing devices 601 and 621.

Here, it is assumed for exemplary purposes that computing device 601 is associated with authorization service 610, while computing device 621 is associated with authorization service 620. It is further assumed that authorization service 610 is representative of an enterprise authorization service (i.e., one that handles authorization and authentication with respect to enterprise employees or personnel), while authorization service 620 is a consumer authorization service (i.e., one that handles authorization and authentication with respect to consumer users). The computing devices may thus also be split between the two domains. For example, computing device 601 may be a work laptop provided to the user, while computing device 621 may be a personal laptop. In both cases, the same user may utilize wearable device 605 to automatically and seamlessly obtain access to each computer.

For example, when approaching computing device 601, wearable device 605 may engage in the aforementioned ranging process with computing device 601, and then an authentication process, to obtain access to the work laptop for the user. Likewise, when approaching computing device 621, wearable device 605 may engage in the aforementioned ranging process with computing device 621, and then an authentication process, to obtain access to the personal laptop for the user.

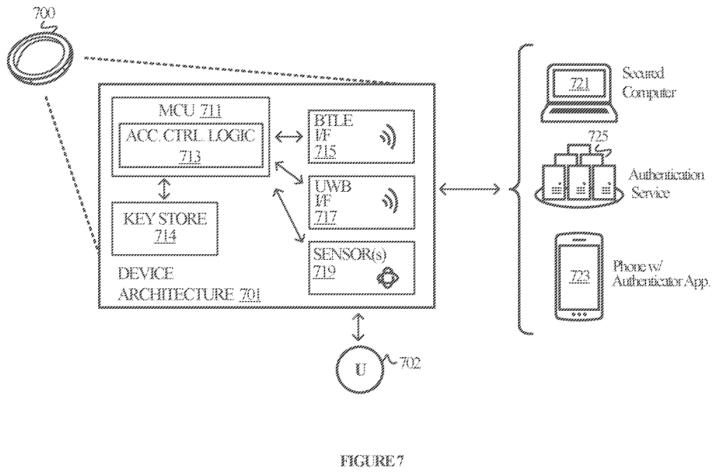

FIG. 7 illustrates a wearable device 700 and a representative hardware architecture that may be employed by the wearable to carry out the processes described herein. For example, device architecture 701 may be employed by wearable device 700 to implement access control process 300. Device architecture 701 includes a microcontroller unit (711), a keystore 714, a Bluetooth Low Energy (BTLE) interface, an ultra-wideband (UWB) interface, and one or more sensors, represented by sensor 719.

In operation, MCU 711 employs access control logic 713 embodied in computer hardware, software, or firmware to facilitate communication with and access control procedures implemented by other devices. For example, wearable device 700 may communicate with secured computing device to which access is desired such as laptops, desktops and services (represented by computer 721). Wearable device 700 may also communicate with a mobile phone 723 or other such device capable of interfacing with an authorization service 725.

Keystore 714 on wearable device 700 is representative of a register, memory location, or other such element of storage capable of storing credential information such as public and/or private key credentials. BTLE interface 715 is representative of circuitry capable of transmitting and receiving BTLE signals to and from other devices. UWB interface 717 is representative of circuitry capable of transmitting UWB signals to and from other devices. Sensor 719 is capable of sensing and reporting on various sensed events such as temperature, motion, and the like. BTLE interface 715, UWB transceiver 717, and sensor 719 are generally coupled with and controlled by MCU 711 and/or other circuitry on wearable device 700.

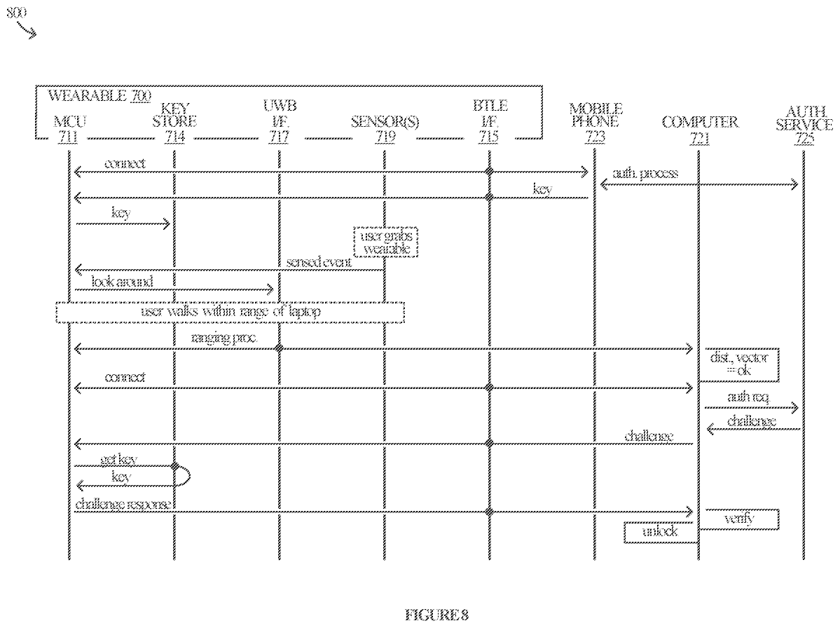

FIG. 8 briefly illustrates an operational sequence 800 that demonstrates with respect to FIG. 7 an implementation of the enhanced device security protocol disclosed herein. In operation, MCU 711 on wearable device 700 connects with mobile phone 723 through BTLE interface 715. When connected, MCU 711 communicates with mobile phone 723 to obtain authentication credentials with which to validate the wearable's association with user 702. (It is assumed for exemplary purposes that user 702 has supplied the appropriate user input to mobile device 723 to allow it to authenticate the user via authorization service 725). Mobile phone 723 provides the authentication credentials (a key) to MCU 711, which MCU 711 stores securely in keystore 714.

User 702 eventually picks up (and presumably wears) wearable device 700, which is detected by sensor 719. Sensor 719 alerts MCU 711 to the sensed event, which triggers MCU 711 to instruct UWB interface to look around for other UWB devices. At this point, it is assumed for exemplary purposes that the user walks within range of computer 721. Thus, both devices discover each other and proceed to initiate a ranging process.

The ranging process is carried out by UWB interface 717 and corresponding equipment on computer 721. The ranging process produces distance, location, and vector information for computer 721 to consider. Here, it is assumed for exemplary purposes that the ranging results satisfy all criteria, thereby allowing wearable device 700 to proceed to the authentication stage. Accordingly, computer 721 connects with wearable device 700 over BTLE to perform the authentication process.

As part of the authentication process, computer 721 sends a request to authorization service 725, in response to which authorization service 725 replies with a challenge. Computer 721 supplies the challenge to wearable device 700, which MCU 711 responds to by retrieving the key from keystore 714. MCU 711 replies to computer 721 with the key which, assuming it remains valid, results in the unlocking of computer 721.

FIG. 9 illustrates computing system 901, which is representative of any system or collection of systems in which the various applications, processes, services, and scenarios disclosed herein may be implemented. Examples of computing system 901 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing system 901 may be implemented as a single apparatus, system, or device or may be implemented in a distributed manner as multiple apparatuses, systems, or devices. Computing system 901 includes, but is not limited to, processing system 902, storage system 903, software 905, communication interface system 907, and user interface system 909. Processing system 902 is operatively coupled with storage system 903, communication interface system 907, and user interface system 909.

Processing system 902 loads and executes software 905 from storage system 903. Software 905 includes and implements access control process 906, which is representative of the processes discussed with respect to the preceding Figures, such as access control process 200 and access control process 300. When executed by processing system 902, software 905 directs processing system 902 to operate as described herein for at least the various processes, operational scenarios, and sequences discussed in the foregoing implementations. Computing system 901 may optionally include additional devices, features, or functionality not discussed for purposes of brevity.

Referring still to FIG. 9, processing system 902 may include a micro-processor and other circuitry that retrieves and executes software 905 from storage system 903. Processing system 902 may be implemented within a single processing device but may also be distributed across multiple processing devices or sub-systems that cooperate in executing program instructions. Examples of processing system 902 include general purpose central processing units, microcontroller units, graphical processing units, application specific processors, integrated circuits, application specific integrated circuits, and logic devices, as well as any other type of processing device, combinations, or variations thereof.

Storage system 903 may comprise any computer readable storage media readable by processing system 902 and capable of storing software 905. Storage system 903 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal. Storage system 903 may be implemented as a single storage device but may also be implemented across multiple storage devices or sub-systems co-located or distributed relative to each other. Storage system 903 may comprise additional elements, such as a controller, capable of communicating with processing system 902 or possibly other systems.

Software 905 (including access control process 906) may be implemented in program instructions and among other functions may, when executed by processing system 902, direct processing system 902 to operate as described with respect to the various operational scenarios, sequences, and processes illustrated herein. For example, software 905 may include program instructions for implementing access control processes and procedures as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtualization software, or other application software. Software 905 may also comprise firmware or some other form of machine-readable processing instructions executable by processing system 902.

In general, software 905, when loaded into processing system 902 and executed, transforms a suitable apparatus, system, or device (of which computing system 901 is representative) overall from a general-purpose computing system into a special-purpose computing system customized to support enhanced access control as described herein. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary storage, as well as other factors.

For example, if the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 907 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 901 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A computing device comprising:
one or more computer readable storage media;
one or more processors operatively coupled with the one or more computer readable storage media; and
program instructions stored on the one or more computer readable storage media that, when executed by the one or more processors, direct the computing device to at least:
exchange wireless communications with a wearable device in proximity to the computing device;
process the wireless communications to determine a position and a direction of motion of the wearable device relative to the computing device, and to determine an authentication status of the wearable device with respect to a user; and
determine whether to grant access to the computing device based at least on the position, the direction, and the authentication status of the wearable device.

2. The computing device of claim 1 wherein the program instructions direct the computing device to grant access to the computing device if the position and the direction of motion of the computing device satisfy distance and direction criteria, and if the authentication status of the wireless device is authenticated.

3. The computing device of claim 2 wherein, to exchange the wireless communications with the wearable device, the program instructions direct the computing device to transmit and receive ultra-wideband (UWB) signals to and from the wearable device.

4. The computing device of claim 3 wherein, to determine the position and the direction of motion of the wearable device relative to the computing device, the program instructions direct the computing device to determine the position and the direction of motion of the wearable device based on one or more characteristics of the UWB signals.

5. The computing device of claim 1 wherein the program instructions direct the computing device to exchange the ultra-wideband signals with the wearable device in response to detecting a presence of the wearable device via other wireless signals that differ from the UWB signals.

6. The computing device of claim 5 wherein the other wireless signals comprise Bluetooth Low-Energy (BTLE) signals.

7. The computing device of claim 1 wherein the wearable device has a bracelet form factor to be worn by the user.

8. A wearable computing device comprising:
one or more processors operatively coupled with the one or more computer readable storage media; and
program instructions stored on the one or more computer readable storage media that, when executed by the one or more processors, direct the wearable computing device to:
authenticate a user associated with the wearable computing device; and
exchange wireless communications with a user computing device to enable the user computing device to determine a position and a direction of motion of the wearable device relative to the user computing device, and to enable the user computing device to determine an authentication status of the wearable device with respect to the user.

9. The wearable computing device of claim 8 wherein the program instructions further direct the wearable computing device to detect a presence of the user based on one or more physiological factors, to authenticate the user in response to detecting the presence of the user, and to de-authenticate the user in response to detecting an absence of the user.

10. The wearable computing device of claim 8 wherein, to exchange the wireless communications with the user computing device, the program instructions direct the wearable computing device to transmit and receive ultra-wideband (UWB) signals to and from the user computing device.

11. The wearable computing device of claim 10 wherein the program instructions further direct the wearable computing device to exchange other wireless signals that differ from the UWB signals prior to exchanging the UWB signals, to enable the user computing device to detect a presence of the wearable computing device.

12. The wearable computing device of claim 11 wherein the other wireless signals comprise Bluetooth Low-Energy (BTLE) signals.

13. The wearable computing device of claim 8 wherein the wearable computing device has a bracelet form factor to be worn on a wrist of the user.

14. The wearable computing device of claim 13 wherein the program instructions further direct the wearable computing device to de-authenticate user when not being worn by the user.

15. A method for controlling access to a computing device, the method comprising:
by the computing device:
exchanging wireless communications with a wearable device in proximity to the computing device;
processing the wireless communications to determine a position and a direction of motion of the wearable device relative to the computing device, and to determine an authentication status of the wearable device with respect to a user associated with the computing device; and
determining whether to grant access to the computing device based at least on the position, the direction of motion, and the authentication status of the wearable device.

16. The method of claim 15 further comprising, by the wearable device:
detecting a presence of the user based on one or more physiological factors;
authenticating the user in response to detecting the presence of the user; and
de-authenticating the user in response to detecting an absence of the user.

17. The method of claim 16 further comprising, by the wearable device, engaging in an authentication process with a mobile device to authenticate the user, and communicating a result of the authentication process to the computing device.

18. The method of claim 15 wherein the program instructions direct the computing device to grant access to the computing device if the position and the direction of motion of the computing device satisfy distance and direction criteria, and if the authentication status of the wireless device is authenticated.

19. The method of claim 18 wherein exchanging the wireless communications with the wearable device comprises transmitting and receiving ultra-wideband (UWB) signals to and from the wearable device.

20. The method of claim 19 wherein exchanging the ultra-wideband signals with the wearable device occurs in response to the computing device detecting a presence of the wearable device via Bluetooth Low-Energy (BTLE) signals.
